(19) United States
(12) Patent Application Publication
(10) Pub. No.: US 2025/0051865 A1
(43) Pub. Date: Feb. 13, 2025

(54) REDUCTION OF IRON ORE METAL AND REACTOR FOR SAID REDUCTION

(71) Applicant: LUOSSAVAARA-KIIRUNAVAARA AB, LULEÅ (SE)

(72) Inventors: Shabbir Taherbhai LAKDAWALA, Luleå (SE); Kamesh Sandeep Kumar TELKICHERLA, Luleå (SE)

(21) Appl. No.: 18/720,106

(22) PCT Filed: Dec. 16, 2022
(86) PCT No.: PCT/SE2022/051197

§ 371 Date: Jun. 14, 2024

(30) Foreign Application Priority Data
Dec. 23, 2021 (SE) 2151619-0

(51) Int. Cl. C21B 13/00

(52) U.S. Cl. CPC C21B 13/0033; C21B 13/0073

(57) ABSTRACT

Reduction reactor and process of effecting reduction of iron ore material to reduced iron material. The process includes feeding iron ore material into a reduction reactor at a top portion thereof, creating a gravitational flow of the material in the reduction reactor from the top portion, axially downwards towards a bottom portion of the reduction reactor; feeding a heated reduction gas into the reduction reactor at the top portion of the reduction reactor, such that the reduction gas creates a co-current flow with the gravitational flow of the material in the reduction reactor; and by means of the reduction gas reducing the iron ore material to reduced iron material in the reduction reactor.

### TECHNICAL FIELD

The present disclosure relates to a process of effecting reduction of iron ore material to reduced iron material and to a reduction reactor for reduction of iron ore material to reduced iron material.

### BACKGROUND ART

In direct reduction iron (DRI) processes reduction of iron ore pellets takes place by reducing the oxygen content of the ore. A traditional apparatus and method for reducing iron oxide to metallic iron is shown for example in U.S. Pat. No. 3,748,120. Iron ore material is fed to the upper portion of a vertical shaft type reduction furnace and removed from the bottom of the furnace. A hot reducing gas having a temperature of at least about 800° C. and consisting essentially of H₂ and CO is added to the gravitational flow of material in the furnace through an inlet between the inlet and outlet of the furnace and flows in a counter-flow relationship to the pellets and exits from the furnace at the top of the furnace after the gas has passed through the iron oxide particulates having heated and reduced the pellets. The iron ore material, such as pellets, may be cooled prior to their discharge from the furnace.

The actual yield from such processes is generally about 68-69%. Different strategies for developing the traditional DRI vertical shaft furnace have been taken to increase the yield.

One way of increasing the yield may be to cause less production of fines in the process. During ore handling operations, wherein physical wear and tear of pellets may result in fines, fines are screened off via screens, before the material is entered into the furnace, thereby resulting in a lower yield. Further, due to the reduction in the shaft furnace, additional fines may be produced in thermal and process fragmentation, exiting the production chain as “slurry”, thereby lowering the yield of the process.

In U.S. Pat. No. 6,132,489 is presented a direct reduction process wherein an iron ore charge with both coarse particles and fines are processed in one single vertical reactor shaft continuously to achieve high metallization rates with reduced clogging in the bed of particles in a moving bed reactor. The vertical reduction reactor has at least one reduction zone, wherein the particles form two types of beds: a fluidized bed and a moving bed. The particles and fines are introduced into the fluidized bed. A reducing gas, at a temperature above about 700° C. is caused to flow upwardly through the reduction zone so that the reducing gas forms a fluidized bed with a first portion of the particles and a non-fluidized bed, where the average size of particles of the first portion is smaller than the average size of particles of the second portion. Metallic-iron-containing particles are caused to over-flow from the fluidized bed and fall through a discharging pipe having an inlet end at the upper part of the fluidized bed.

In U.S. Pat. No. 9,273,368 is shown another strategy for improving the yield of the DRI process. Here iron oxide pellet or lump coated with a mineral solution is fed to a pre-reduction zone, a transition zone, a metallization zone, and a cooling zone while passing rich fuel gas produced by external partial combustion with a sub-stoichiometric volume of air upwardly through the pre-reduction zone in counter-current flow so as to preheat the coated charge to a temperature in the range of about 1000-1300° C. and partially reduce the coated charge, and passing reducing gas downwardly through the metallization zone in co-current flow so as to complete the reduction of the iron oxide to metallic iron.

Although different strategies have been taken to improve the DRI process and furnaces, there is still a request for an improved process of effecting reduction of iron ore material to reduced iron material.

### SUMMARY OF THE INVENTION

It is an object of the present disclosure to provide a process of effecting reduction of iron ore material to reduced iron material that alleviates or overcomes at least some of the disadvantages with prior art reduction processes. A further object is to provide a reduction reactor for such reduction of iron ore material.

The invention is defined by the appended independent patent claims. Non-limiting embodiments emerge from the dependent claims, the appended drawings and the following description.

According to a first aspect, there is provided a process of effecting reduction of iron ore material to reduced iron material. The process comprises to provide a reduction rector, feeding iron ore material into the reduction reactor at a top portion thereof, and creating a gravitational flow of the iron ore material in the reduction reactor from the top portion, axially downwards towards a bottom portion of the reduction reactor. A heated reduction gas is fed into the reduction reactor at the top portion of the reduction reactor, such that the reduction gas creates a co-current flow with the gravitational flow of the material in the reduction reactor. By means of the reduction gas the iron ore material is reduced to reduced iron material in the reduction reactor. Spent reduction gas is removed from the reduction reactor at a gas outlet at a lower section of the reduction reactor, and reduced iron material is removed from the reduction reactor at the bottom portion thereof.

The iron ore material added to the top portion of the reduction reactor may be a non-reduced iron ore material, i.e. no pre-reduction is taking place before adding the material to the reduction reactor.

The iron ore material may be iron ore pellet and/or iron ore lump and/or iron ore agglomerate. With pellets is here meant spheres of typically 6-16 mm, or spheres having a diameter of 3-18 mm, or 6-18 mm.

The iron ore material added at the top portion of the reduction reactor forms a packed bed of material descending with gravity through the reduction reactor.

The reduction gas creates a co-current flow with the gravitational flow of the iron ore material and the later formed reduced iron material in the reduction reactor.

The reduction reactor may be a reduction furnace or vertical reduction furnace.

The iron ore material may have a temperature when being fed to the reduction reactor of 0-1300° C. The iron ore material may, hence, be cold or heated when added.

If heated, the thermal potential/energy of the hot material can be utilized in the reduction reactor.

The heated reduction gas may have a temperature of 500-1000° C. when being fed to the top portion of the reduction reactor.

The process described above is a reduction process that can process heated iron ore material efficiently. As heated iron ore material can be supplied into the reduction reactor and processed into reduced iron material/metallized material, the method can be used/integrated directly after and in line with a pelletizing plant.

To balance the thermal energy requirements of the process and to obtain a reduction process that is isothermal or close to isothermal, i.e. a process expected to improve speed of reduction and reduce reduction time, such that there is no major drop in temperature during the reduction process and the difference between the gas temperature above and below the bed of iron ore material in the reactor should be minimum, the temperature of the added reduction gas may have to be adjusted in relation to the temperature of the added iron ore material.

To improve the yield of the process, the temperature choice should preferably overcome low temperature disintegration during Hematite to Magnetite transformation, which is most dominant/significant between 450-650° C. A temperature above this range during the reduction/metallization in the reduction reactor is expected to improve the yield of the iron reduction process. By bypassing the low temperature disintegration during Hematite to Magnetite transformation the proportion of fragmented solids formed from the iron ore material can be reduced in the process. With a lower amount of fragmented solids generated, a higher yield may be obtained. With fragmented solids is here meant any form and size of fragmented solids, such as dust/fines/small particulate material, such as less than about 6 mm.

In case of a cold feed charging, i.e. an iron ore material having a temperature of 200° C. or less, the corresponding reduction gas temperature should be 950-1000° C. to meet the above requirement.

When the temperature of the iron ore material fed into the reduction reactor is high, i.e. in the range of 1200-1300° C., the corresponding reduction gas temperatures needed is lower, such as in the range of 400-700° C. to balance such energy requirements of the process.

With the above process, the rate of the reduction process can be made faster as compared to prior art processes, resulting in a reduction reactor design that could be a low volume high throughput reactor. The output would then directly depend on choice of iron ore material temperature and reduction gas temperature.

Feeding the reduction gas to the top portion of the reduction reactor, such that there is a co-current flow of heated gas and material through the reactor, gives a more efficient reduction process and a reduction process that can be accelerated and needs shorter time to be completed, as compared to conventional reduction processes. Using the present process, the resulting reduction/metallization may be as high as 94% or more. Further, a reduction reactor with smaller size/shorter than what is standard today may be used.

As the reduction gas is entered at the top portion of the reduction reactor, less material may be lost to fragmented solids as compared to when gas is exiting at the top of the reduction reactor as low temperature disintegration is most dominant at upper part of reduction reactor. With a lower amount of fragmented solids generated, this results in a higher yield.

The spent reduction gas removed from the reduction reactor may have a temperature of 600-900° C.

The reduced iron material/metallized material removed from the reduction reactor may have a temperature of 600-850° C.

The lower section extends from the bottom portion to a mid-portion of the reduction reactor. The gas outlet of the reduction reactor may be located at the bottom portion of the reduction reactor. Alternatively, the gas outlet may be located at a portion/section of the reduction reactor, as seen in a direction of gravitational flow of material in the reduction reactor, located above or immediately above the bottom portion of the reduction reactor.

The iron ore material when being fed into the reduction reactor may have a temperature of 0-1300° C.

The iron ore material may have a temperature of 0-1300° C., or 30-1300° C., or 100-1300° C., or 200-1300° C., or 300-1300° C., or 400-1300° C., or 500-1300° C., or 600-1300° C., or 700-1300° C., or 800-1300° C., or 900-1300° C., or 1000-1300° C., or 1100-1300° C., or 1200-1300° C., or 0-1200° C., or 0-1100° C., or 0-1000° C., or 0-900° C., or 0-800° C., or 0-700° C., or 0-600° C., or 0-500° C., or 0-400° C., or 0-300° C., or 0-200° C., or 0-100° C., or 500-900° C., or 800-1100° C., preferably >800° C.

The reduction gas when fed into the reduction reactor may have a temperature of 500-1000° C.

The temperature of the reduction gas may preferably be 500-900° C. As discussed above, the choice of reduction gas temperature is dependent on the temperature of the iron ore material added to the reduction reactor.

In case of cold iron ore material, the reduction gas temperature needed will be higher, in range from 950-1000° C. Such a high temperature might need oxygen injection into the reduction gas to obtain this high temperature. At lower temperatures, no oxygen injection may be needed. Further, there is no decrease in reduction potential. Absence of oxygen injection system is expected to save significant amount of reduction gas wastage via oxidation to reach higher gas temperatures.

A temperature of the spent reduction gas removed from the reduction reactor may be at least 600° C., and a temperature of reduced iron material removed from the reduction reactor may be at least 600° C.

If the temperatures of the spent reduction gas and reduced iron material removed from the reduction reactor is each at least 600° C., reduction/metallization is taking place in the reduction reactor at a temperature above the critical low temperature disintegration during Hematite to Magnetite transformation, which is most dominant/significant between 450-650° C.

As the temperature of the removed reduced iron material has a temperature of at least 600° C., this hot reduced iron material can be charged directly to a down-stream processing unit, which may save a significant amount of thermal energy in that down-stream process.

In one example, hot moulded briquettes can be formed of the removed hot reduced iron material. This will result in a significant advantage for a briquetting process immediately following the reduction process, where the principal briquette physical quality dominant factor is the temperature of feed to the briquetting machine. The higher the feed temperature, the higher the physical quality of briquette in terms of density and tumble strength.

Traditionally, iron ore material, such as pellets are coated (using materials such as limestone, dolomite and olivine and bentonite as a binder) to avoid clustering/sticking during the reduction process if temperatures in the reactor are higher than 900° C.

In the present method no such coating may be necessary of the iron ore material and non-coated material can be used. In the present process, there is nowhere in the reactor after the reduction of the iron ore material that reaches a temperature of 900° C. or more. Thereby, there is no or little clustering/sticking in the reactor due to soft or iron to iron sintering of reduced material, and, hence, no or little clustering/sticking of material in the reactor. If no coating is needed, the iron ore material can be used dry and uncoated. This saves on processing and operating costs of coating.

The reduction gas fed into the reduction reactor may comprise in volume 90% or more of hydrogen.

The reduction gas fed into the reduction reactor may comprise in volume 90% or more of H₂, or at least 91%, 92%, 93%, 94%, 95%, 96%, 97%, 98%, or at least 99% H₂, preferably at least 97% H₂. The rest being H₂O and possibly other gases like N₂.

Using pure H₂ or close to pure H₂ the reduction rate may be faster and reduction time shorter as compared to using reduction gases comprising lower amounts of hydrogen. This will improve productivity or throughput of the process. Further, there may be less production of fragmented solids in the process. Using H₂ there is less swelling of the iron ore material as compared to when the reduction gas comprises CO (as in standard reduction processes). The reduction gas used here may comprise no carbon-containing gas components.

The introduction of the heated reduction gas into the reduction reactor takes place at a high pressure point at the top portion of the reactor.

The iron ore material may be reduced to iron material in the reduction reactor in an isothermal or close to isothermal reduction process.

An isothermal or close to isothermal reduction process improves speed of the reduction and reduces the reduction time. In an isothermal reduction process there is no major drop in temperature during the reduction process and the difference between the gas temperature above and below the bed of iron ore material in the reactor should be minimum or as low as possible. To balance the thermal energy requirements of the process and to obtain a reduction process that is isothermal or close to isothermal, the temperature of the added reduction gas may have to be adjusted in relation to the temperature of the added iron ore material. In one example the temperature of the reduction gas fed into the reduction reactor could be about 900° C. and the temperature of the iron ore material fed into the reduction reactor could be about 800° C.

Dry fragmented solids may be separated from spent reduction gas removed from the reduction reactor, and re-entered into the reduction reactor at a fragmented solids inlet provided at a point below, as seen in a direction of gravitational flow of material in the reduction reactor, the gas outlet of the reduction reactor.

Reinjecting the dry fragmented solids is expected to improve the material/solid yield of the process.

According to a second aspect there is provided a reduction reactor for reduction of iron ore material to reduced iron material. The reduction reactor comprises a material entry arranged at a top portion of the reduction reactor configured for feeding of iron ore material into the reduction reactor, a gas entry arranged at the top portion of the reduction reactor, configured for feeding of heated reduction gas into the reduction reactor, wherein the reduction reactor, the material entry and the gas entry are arranged such that material fed through the material entry and reduction gas fed through the gas entry creates a co-current flow from the top portion axially downwards towards a bottom portion of the reduction reactor, such that the iron ore material is reduced in the reduction reactor. A gas outlet is arranged at a lower section of the reduction reactor, configured for removal of spent reduction gas from the reduction reactor, and a material exit is arranged at a bottom portion of the reduction reactor, configured for removal of reduced iron material from the reduction reactor.

The spent reduction gas is removed from the reduction reactor at the gas outlet. This is a low pressure point in the reduction reactor. The gas outlet is preferably arranged/designed appropriately to avoid fragmented solids, such as fines/dust/pellets, carry over into the spent reduction gas.

The reduction reactor may further comprise a separator arranged at/after the gas outlet for separating dry fragmented solids from the spent reduction gas.

The reduction reactor may further comprise a solid recycler arranged in connection with the separator, and arranged to re-enter dry fragmented solids separated from the spent reduction gas into the reduction reactor at a fragmented solids inlet arranged at a point below, as seen in a direction of gravitational flow of the material in the reduction reactor, the spent reduction gas outlet.

The separated dry fragmented solids may be re-entered into the reduction reactor using a recycler ejector.

### BRIEF DESCRIPTION OF THE DRAWINGS

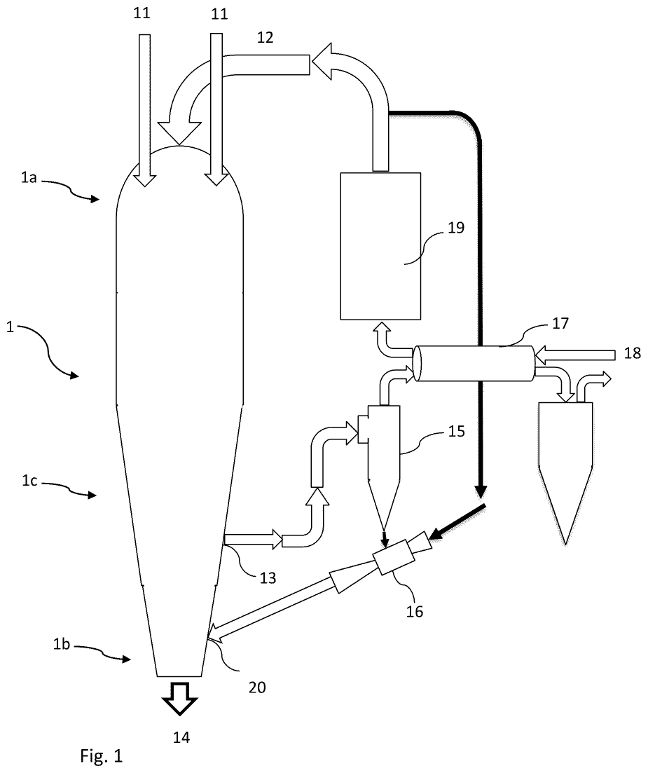

In FIG. 1 is illustrated a novel reduction reactor.

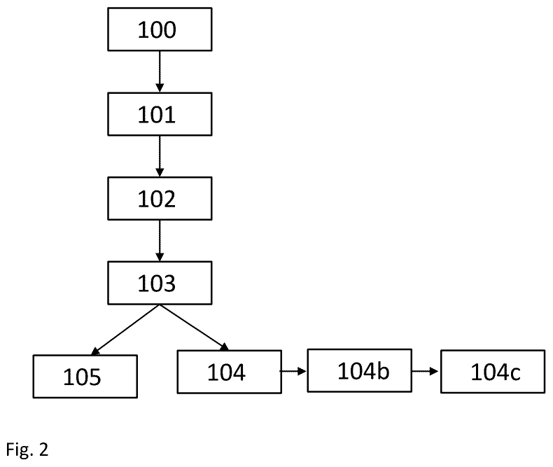

In FIG. 2 is schematically illustrated a process of effecting reduction of iron ore material to reduced iron material.

### DETAILED DESCRIPTION

Different strategies have been taken to improve iron ore reduction processes and the reactors used for such reductions. Below is described a process and reduction reactor in which the rate of reduction may be faster, the metallization degree improved and a material/solid yield of the process increased, as compared to standard reduction processes. This process and reduction reactor can further be arranged for efficient processing of hot iron ore material. Thereby, hot iron ore material, e.g. pellet, can be added to the reduction reactor directly from a pelletizing plant.

In FIG. 1 is illustrated such a novel reduction reactor 1 and in FIG. 2 a process of effecting reduction of iron ore material, such as iron ore pellet and/or iron ore lump and/or iron ore agglomerate, to reduced iron material. The provided 100 reduction reactor 1 has a material entry 11 arranged at a top portion 1a of the reduction reactor configured for feeding 101 of iron ore material into the reduction reactor. The iron ore material added at the top portion of the reduction reactor may have a temperature of 0-1300° C. and forms a packed bed of material descending with gravity through the reduction reactor from the top portion 1a towards a bottom portion 1b. A gas entry 12 is arranged at the top portion 1a of the reduction reactor 1, configured for feeding 102 of heated reduction gas having a temperature of 500-1000° C. into the reduction reactor 1. The reduction gas fed into the reduction reactor may comprise in volume 90% or more of H₂, preferably 97% or more of H₂. The rest being H₂O and possibly other gases such as N₂.

Material fed through the material entry 11 and reduction gas 12 fed through the gas entry creates a co-current flow from the top portion 1a axially downwards towards the bottom portion 1b of the reduction reactor 1, such that the iron ore material is reduced 103 in the reduction reactor. A gas outlet 13 is arranged at a lower section 1c of the reduction reactor 1, configured for removal 104 of spent reduction gas from the reduction reactor 1. A material exit 14 is arranged at a bottom portion 1b of the reduction reactor 1, configured for removal 105 of reduced iron material from the reduction reactor 1. A fragmented solids inlet 20 is arranged at a point below, as seen in a direction of gravitational flow of material in the reduction reactor, the gas outlet 13 of the reduction reactor.

To balance the thermal energy requirements of the process and to obtain a reduction process in the reduction reactor 1 that is isothermal or close to isothermal, the temperature of the reduction gas added to the reactor may have to be adjusted in relation to the temperature of the added iron ore material. An isothermal process is expected to give a more controlled reduction reaction than a non-isothermal process and to improve speed of the reduction and reduce the reduction time. In an isothermal reduction process there is no major drop in temperature during the reduction process and the difference between the gas temperature above and below the bed of iron ore material in the reactor should be minimum.

Low temperature disintegration during Hematite to Magnetite transformation is most dominant/significant between 450-650° C. A temperature above this range during the reduction/metallization in the reduction reactor is expected to improve the yield of the iron reduction process.

To fulfil this requirement, the spent reduction gas removed 104 from the reduction reactor may have a temperature of 600-900° C. and the reduced iron material/metallized material removed 105 from the reduction reactor 1 may have a temperature of 600-850° C.

In case of a cold feed charging, i.e. an iron ore material having a temperature of 200° C. or less, the corresponding reduction gas temperature should be 950-1000° C. to meet the above requirement. When the temperature of the iron ore material fed into the reduction reactor is high, i.e. in the range of 1200-1300° C., the corresponding reduction gas temperatures needed is lower, such as in the range of 400-700° C. to balance such energy requirements of the process.

A nominal operating pressure of the reduction reactor may be in a range of about 1-7 bar to consider an economical/condensed design of the reduction processes.

After removal 105 of the reduced material from the reduction reactor 1, the process may comprise a further step of cooling the reduced/metallized material.

Dry fragmented solids may be separated 104b from the spent reduction gas removed 104 from the reduction reactor 1 using a separator 15 arranged at/after the spent reduction gas outlet 13. The separated dry fragmented solids may thereafter be re-entered 104c in to the reduction reactor 1 at the fragmented solids inlet 20 arranged at a point below the gas outlet 13. The dry fragmented solids, such as fines/dust/pellets, may be separated from the spent reduction gas using for example a dry cyclone separator or baffled separator 15. The dry fragmented solids recovered from the spent reduction gas is expected to be of high iron content and abrasive in nature with larger friction factor. To facilitate a seamless recycling of recovered solids into the lower portion of the reduction reactor a recycler ejector 16 may be used.

The separation of dry fragmented solids from the spent reduction gas may be a pre-cleaning/separation step of the gas before the gas proceeds to a next processing unit. The heat from the spent reduction gas can be recovered via a gas—gas heat exchanger 17 by using cold reduction gas 18 on the way to a reduction gas heater 19, thereby improving thermal efficiency of the process.

For recycling of dry fragmented solids separated from the spent reduction gas back into the reduction reactor a small stream of high-pressure, high-temperature reduction gas may be used as a medium of injection. This constant flow of reduction gas will then be the driving fluid media that ensure continuous functioning/operation of the ejector. The gas for driving/operating the solids ejector can be driven by an alternative gas like nitrogen if the recycled solids are diverted to an alternative/external system. The solids in this closed loop are not expected to increase or accumulate with time as the exit velocity of the high bulk flow of reduced material at the bottom portion of the reduction reactor is expected to entrain the recovered fragmented solids to product and prevent accumulation/up-flow.

The above described process and reduction reactor was simulated for different material temperatures and gas temperatures using the HSC Chemistry®software. In Table 1 is summarised the different parameters and parameter values used in the simulations.

TABLE 1

| | Test 1 | Test 2 | Test 3 | Test 4 |
|---|---|---|---|---|
| Pellet mass flow | 1.410 | 1.410 | 1.410 | 1.410 |
| rate (tonne/h) | | | | |
| Pellet feed | 1300 | 800 | 200 | 0 |
| temperature (° C.) | | | | |
| Reduction gas | 685 | 900 | 950 | 1000 |
| temperature to | | | | |
| reactor (° C.) | | | | |
| Reduction gas | 97 | 97 | 97 | 97 |
| composition, % | | | | |
| H₂ | | | | |
| Reduction gas | 3 | 3 | 3 | 3 |
| composition, % | | | | |
| H₂O | | | | |
| Gas temperature | 810 | 821 | 660 | 642 |
| from reactor (° C.) | | | | |
| Reduced material | 810 | 820 | 660 | 642 |
| temperature (° C.) | | | | |
| Reduced material | 94 | 94 | 94 | 94 |
| metallization, % | | | | |
| Reduced material | 1.016 | 1.016 | 1.016 | 1.016 |
| from reactor | | | | |
| (tonne) | | | | |

In these simulations the iron ore material fed into the reduction reactor was an iron or pellet of standard form and composition, using a mass flow rate of 1.410 tonne/h. The temperature of the pellet feed when entering the reduction reactor was set to 1300° C., 800° C., 200° C. and 0° C., respectively, and the temperature of the reduction gas when entered into the reduction reactor was set to 685° C., 900° C., 950° C. and 1000° C., respectively. The simulated gas when fed into the reactor had a composition of 97% H₂ and 3% H₂O. The temperature of the output material was then 810° C., 820° C., 660° C. and 642° C., respectively, and the temperature of the spent reduction gas 810° C., 821° C., 660° C. and 642° C., respectively. With such optimised parameters, the reduced material metallization rate was calculated as 94%.

The parameter values used in test 2: a pellet feed temperature of 800° C. and a reduction gas temperature of 900° C. when fed into the reactor, are expected to give both an isothermal or close to isothermal reduction process and a low level of low temperature disintegration, as discussed above. The parameter values used in the other tests, although giving satisfactory reduced material metallization levels, may not give as high a yield or as high a reduction speed as may be obtained with the parameter values used for test 2.

1. A process of effecting reduction of iron ore material in the form of iron ore pellet and/or iron ore agglomerate to reduced iron material, the process comprising:
providing a reduction reactor;
feeding iron ore material having a temperature of 100-1300° C. into the reduction reactor at a top portion thereof, creating a gravitational flow of a packed bed of iron ore material descending in the reduction reactor from the top portion, axially downwards towards a bottom portion of the reduction reactor;
feeding heated reduction gas into the reduction reactor at the top portion of the reduction reactor, such that the heated reduction gas creates a co-current flow with the gravitational flow of the iron ore material in the reduction reactor;
reducing the iron ore material to reduced iron material by the heated reduction gas in the reduction reactor;
removing spent reduction gas from the reduction reactor at a gas outlet at a lower section of the reduction reactor; and
removing reduced iron material from the reduction reactor at the bottom portion thereof.

2. The process of claim 1, wherein the reduction gas when being fed into the reduction reactor has a temperature of 500-1000° C.

3. The process of claim 1, wherein a temperature of the spent reduction gas removed from the reduction reactor is at least 600° C., and a temperature of reduced iron material removed from the reduction reactor is at least 600° C.

4. The process of claim 1, wherein the heated reduction gas fed into the reduction reactor comprises in volume 90% or more of hydrogen.

5. The process of claim 1, wherein the iron ore material is reduced to iron material in the reduction reactor in an isothermal or close to isothermal reduction process.

6. The process of claim 1, wherein dry fragmented solids is separated from spent reduction gas removed from the reduction reactor, and re-entered in to the reduction reactor at a fragmented solids inlet arranged at a point below, as seen in a direction of gravitational flow of the iron ore material in the reduction reactor, the gas outlet of the reduction reactor.

7. A reduction reactor for reduction of iron ore material in the form of iron ore pellet and/or iron ore agglomerate to reduced iron material, the reduction reactor comprising:
a material entry arranged at a top portion of the reduction reactor configured for feeding of iron ore material having a temperature of 100-1300° C. into the reduction reactor;
a gas entry arranged at the top portion of the reduction reactor, configured for feeding of heated reduction gas into the reduction reactor;
wherein the reduction reactor, the material entry and the gas entry are arranged such that material fed through the material entry creates a gravitational flow of a packed bed of iron ore material descending in the reduction reactor, and reduction gas fed through the gas entry creates a co-current flow with the gravitational flow of the material in the reduction reactor from the top portion axially downwards towards a bottom portion of the reduction reactor, such that the iron ore material is reduced in the reduction reactor;
a gas outlet arranged at a lower section of the reduction reactor, configured for removal of spent reduction gas from the reduction reactor, and a material exit arranged at a bottom portion of the reduction reactor, configured for removal of reduced iron material from the reduction reactor.

8. The reduction reactor of claim 7, further comprising a separator arranged at/after the gas outlet for separating dry fragmented solids from the spent reduction gas.

9. The reduction reactor of claim 8, further comprising a solid recycler arranged in connection with the separator, and arranged to re-enter dry fragmented solids separated from the spent reduction gas into the reduction reactor at a fragmented solids inlet arranged at a point below, as seen in a direction of gravitational flow of the material in the reduction reactor, the gas outlet.
